(19) United States
(12) Patent Application Publication
(10) Pub. No.: US 2024/0331907 A1
(43) Pub. Date: Oct. 3, 2024

(54) ELECTRONIC COMPONENT

(71) Applicant: TDK CORPORATION, Tokyo (JP)

(72) Inventors: Hidenobu UMEDA, Tokyo (JP); Masaki TAKAHASHI, Tokyo (JP); Kaori SASAKI, Tokyo (JP); Nami ENOMOTO, Tokyo (JP)

(73) Assignee: TDK CORPORATION, Tokyo (JP)

(21) Appl. No.: 18/616,887

(22) Filed: Mar. 26, 2024

(30) Foreign Application Priority Data
Mar. 31, 2023 (JP) 2023-058383

(51) Int. Cl. H01F 5/06; C03C 10/00

(52) U.S. Cl. CPC H01F 5/06; C03C 10/0045

(57) ABSTRACT

An electronic component includes a glass ceramic sintered bod. The glass ceramic sintered body includes a main phase grain including at least one of a cordierite phase and an indialite phase, and a coating layer including a forsterite phase covering the main phase grain.

### BACKGROUND

The present disclosure relates to an electronic component which, for example, includes a glass ceramic sintered body.

As for ceramics used for an electronic component such as a capacitor, an inductor, a substrate, or so, a material with low permittivity (ε) is generally used (for example, a composition of Patent Document 1) in order to reduce stray capacitance generated between an internal conductor and a terminal.

For recent electronic components, a high-frequency property is demanded due to development of 5th generation mobile communication system. Regarding the electronic components needing the high-frequency property, the concern is noise caused by the stray capacitance, hence, it is demanded to have even lower permittivity. Also, in recent years, due to development in electronic vehicles, lower permittivity and also improved component strength are in demand as well. The composition of the material which forms a core for improving the above-mentioned property is developing; however, in the case of using such material as a ceramic sintered body, it is still difficult to achieve low permittivity, improved strength, and high Q-value at the same time. Thus, in reality, such material has not been produced yet.
[Patent Document 1] JP Patent Application Laid Open No. 2004-168557

### SUMMARY

The present disclosure is achieved in view of such circumstances, and the object is to provide an electronic component capable of achieving low permittivity, improved strength, and high Q-value at the same time.

In order to achieve the above-mentioned object, the electronic component according to a preferable embodiment of the present disclosure includes:
a glass ceramic sintered body, wherein
the glass ceramic sintered body includes a main phase grain including at least one of a cordierite phase and an indialite phase, and a coating layer including a forsterite phase covering the main phase grain.

In the electronic component according to this embodiment, it is possible to achieve low permittivity, high strength, and high Q-value at the same time. The reason behind this is not necessarily clear, however, below reasoning is speculated. In general, the cordierite phase and the indialite phase, particularly of the indialite phase, have relatively low thermal expansion coefficient compared to the forsterite phase. Thus, since the coating layer with relatively high thermal expansion coefficient covers the main phase grain with relatively low thermal expansion coefficient, stress is kept applied on the main phase grain. Therefore, this makes it is difficult for cracks to extend when the stress is applied from outside, hence, low permittivity and high strength can be both achieved, and also high Q-value can be maintained.

Also, an electronic component according to another preferable embodiment of the present disclosure includes:
a glass ceramic sintered body, wherein
the glass ceramic sintered body includes a main phase grain including a composite oxide including Si, Mg, and Al as main components, and a coating layer covering the main phase grain and including a composite oxide including Mg, Si, and Zn as main components.

For example, the thermal expansion coefficient of the composite oxide including Si, Mg, and Al as the main components to form the cordierite phase or the indialite phase is lower than thermal expansion coefficient of the composite oxide including Mg, Si, and Zn as the main components to form the forsterite phase. Therefore, by covering the main phase grain having relatively low thermal expansion coefficient with the coating layer having relatively high thermal expansion coefficient, stress is kept applied on the main phase grain. Thus, this makes it is difficult for cracks to extend when the stress is applied from outside; hence, low permittivity and high strength can be both achieved and also high Q-value can be maintained.

Preferably, the main phase grain includes the indialite phase. Indialite has higher Q-value compared to cordierite, thus, low permittivity and high strength can be both achieved, and also Q-value is further improved.

Preferably, a grain size of the main phase grain is 0.35 μm or larger. The larger the grain size is, the stronger the strength of the electronic component is; however, if the grain size is too large, Q-value tends to decrease and also the permittivity tends to increase.

Preferably, a thickness of the coating layer is 0.02 μm or thicker.

By maintaining the thickness of the coating layer within an appropriate range (for example, the thickness corresponds to an amount of forsterite or corresponds to an amount of the composite oxide including Mg, Si, and Zn), stress applied on the main phase grain from the coating layer is maintained within an appropriate range, and it is thought that cracks can be suppressed from forming. Further, by maintaining the thickness of the coating layer within an appropriate range, the strength of the electronic component is improved. This is because compression stress applied on the main phase grain is maintained within an appropriate range, and thus it is thought that the strength is improved.

Preferably, the coating layer may include the willemite phase (in other words, the composite oxide including Mg, Si, and Zn as main components in which relatively more Zn is included compared to Mg. The same applies hereinbelow.) together with the forsterite phase (in other words, the compound oxide including Mg, Si, and Zn as the main components in which relatively more Zn is included compared to Mg. The same applies hereinbelow.). By configuring part of the coating layer with the willemite phase, it is possible to lower the permittivity and increase Q-value.

Preferably, the area ratio of the willemite phase to the total area of forsterite phase and willemite phase in the coating layer is within a range of 0 to 73%, more preferably within a range of 1 to 73%, or even more preferably within a range of 7 to 70%. If the area of the willemite phase is too large, the strength of the electronic component decreases, and also the thermal expansion coefficient decreases, thus it may become difficult to simultaneously fire electrodes (for example, Ag) and a glass ceramic together.

Preferably, the coating layer includes Ce or Cu. By including Ce or Cu in part of the coating layer, the strength of the electronic component is further enhanced. These elements are included in the sintered body not as filler particles, and it is thought that these are diffused to the surface of the coating layer or the main phase grain.

### BRIEF DESCRIPTION DRAWINGS

FIG. 1 is cross sectional diagram of a chip coil as an electronic component according to one embodiment of the present disclosure.

FIG. 2A is an image showing a part of a cross-section of a glass ceramic sintered body according to an example of the present disclosure to which STEM-EDS analysis has been carried out.

FIG. 2B is an image showing a part of a cross-section of a glass ceramic sintered body according to a comparative example of the present disclosure to which STEM-EDS analysis has been carried out.

FIG. 3A is an image showing a part of a cross-section of a glass ceramic sintered body according to an example of the present disclosure to which XRD analysis has been carried out.

FIG. 3B is an image showing a part of a cross-section of a glass ceramic sintered body according to a comparative example of the present disclosure to which XRD analysis has been carried out.

### DETAILED DESCRIPTION

Hereinafter, embodiments of the present disclosure are described. Note that, the present disclosure is not limited to the below described embodiments. Also, the configurational elements shown in below include modifications and similar configurations which can be easily anticipated by one skilled in the art. Further, the configurational elements described in below can be combined accordingly.

### (Coil Electronic Component)

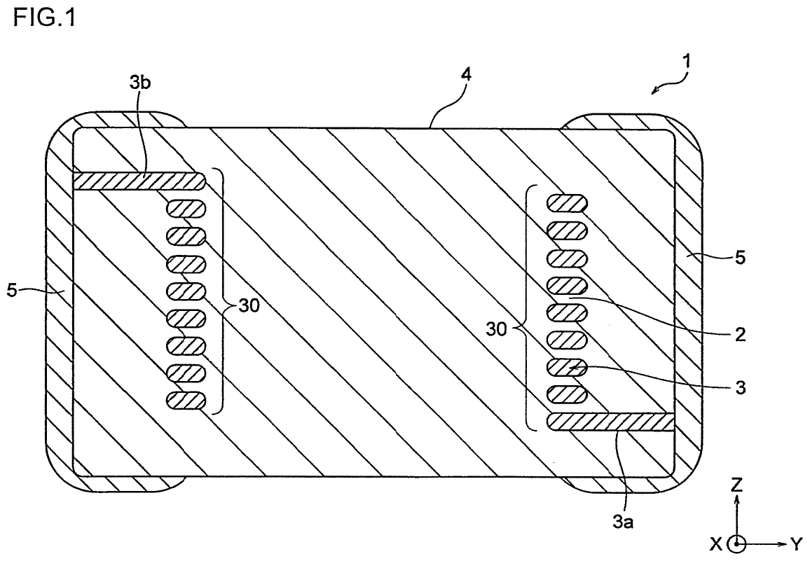

As shown in FIG. 1, a chip coil 1 as an electronic component according to one embodiment of the present disclosure includes a chip element 4 in which a ceramic layer 2 and an internal electrode layer 3 are provided so that the ceramic layer and the internal electrode layer are placed on each other in alternating manner in Z-axis direction when viewed from X-axis direction.

The internal electrode layer 3 at each layer has a ring shape (circular shape, oval shape, or polygonal shape) or a C-shape when viewed from Z-axis direction; and the internal electrode layer 3 is continuous in a spiral form by an internal electrode connection through hole electrode (not shown in the figure) or a step form electrode which runs through the adjacent ceramic layer 2. Thereby, a coil conductor 30 is formed.

At both ends in Y-axis direction of the chip element 4, terminal electrodes 5 are formed. The coil conductor 30 continuous in a spiral form has lead electrodes 3a and 3b which are pulled out to opposite sides in Y-axis direction; and the terminal electrodes 5 are connected with the lead electrodes 3a and 3b. That is, the terminal electrodes 5 are connected with the both ends of the coil conductor 30 configuring a closed magnetic coil (a winding coil pattern).

In the present embodiment, the ceramic layer 2 and the internal electrode layer 3 are placed on each other in Z-axis direction; upper and lower faces of the chip element 4 are parallel to a XY plane; and end faces opposing against each other in Y-axis direction where the terminal electrodes 5 are formed are parallel to a XZ plane. Note that, X-axis, Y-axis, and Z-axis are perpendicular to each other. In the multilayer chip coil 1, a winding axis of the coil conductor 30 matches Z-axis.

An outer shape and size of the chip element 4 are not particularly limited, and these can be any shape and size depending on the needs. Usually, the shape is a cuboid shape, and for example, X-axis dimension is 0.1 to 0.8 mm, Y-axis dimension is 0.2 to 1.6 mm, and Z-axis dimension is 0.1 to 1.0 mm.

Also, a thickness of the ceramic layer 2 between the electrodes and a thickness of a base are not particularly limited, and the thickness of the ceramic layer 2 between the electrodes (that is, the thickness of the space between the internal electrode layers 3 and 3) may be within a range of 2 to 50 μm, and the thickness of the base (that is, this thickness refers to the distance from Z-axis end of the coil conductor 30 to the upper face of the chip 4 and the distance from Z-axis end of the coil conductor 30 to the lower face of the chip 4) may be within a range of 5 to 300 μm or so.

In the present embodiment, the terminal electrodes 5 are not particularly limited; and the terminal electrodes 5 may be formed by baking a conductive paste including Ag, Pd, and so on as main components on the outer surface of the chip element 4, then carrying out electroplating. For electroplating, Cu, Ni, Sn, and so on may be used.

The coil conductor 30 preferably includes Ag (including Ag alloy), and for example, it may be configured of a simple substance of Ag, Ag—Pd alloy, and so on. Also, as subcomponents of the coil conductor, Cu, Zr, Si, Al, Ti, Mg, and oxides thereof may be included.

The ceramic layer 2 is configured of a glass ceramic sintered body according to one embodiment of the present disclosure. In below, the glass ceramic sintered body is described in detail.

### (Glass Ceramic Sintered Body)

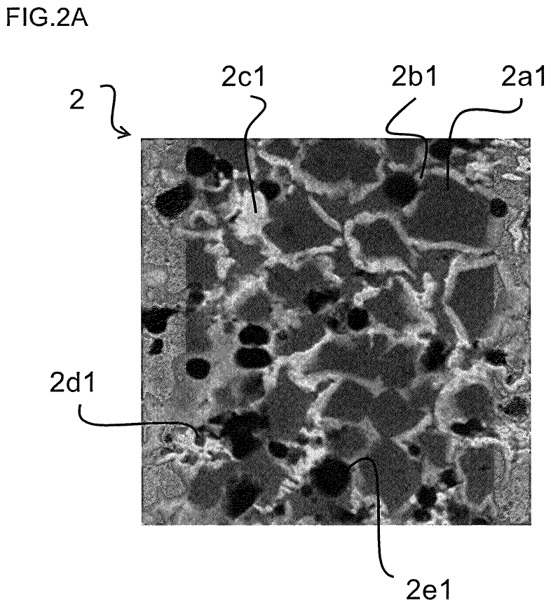

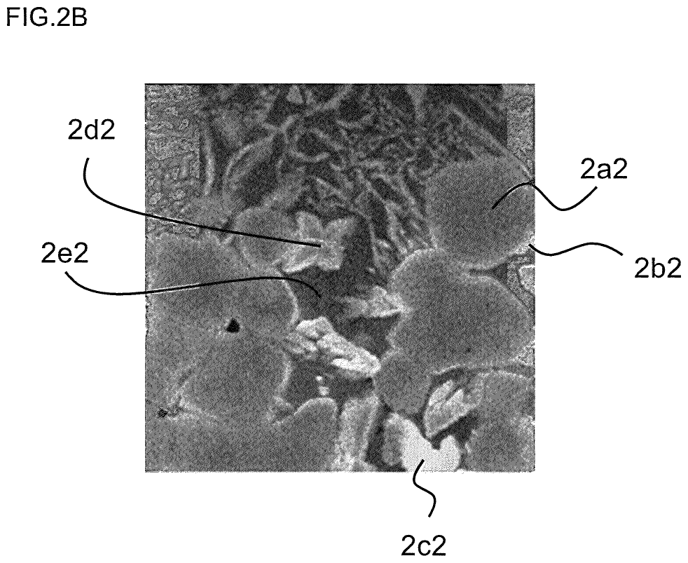

As shown in a cross-section image of STEM-EDS of FIG. 2A, the glass ceramic sintered body according to the present embodiment configuring the ceramic layer 2 includes a main phase grain 2a1 which is a crystal grain, a coating layer 2b1 and an auxiliary coating layer 2c1 which exist so as to cover the main phase grain 2a1. Note that, “exist so as to cover the main phase grain 2a1” means that, in the cross-section image, the main phase grain 2a1 does not necessarily have to be completely covered, and 50% or more, or may be 80% or more of circumference of the main phase grain 2a1 may be covered.

In the present embodiment, the main phase grain 2a1 is configured of the composite oxides including Si, Mg, and Al as the main components; and for other components, oxides of Zn, Zr, Ce, Cu, B, Ca, Sr, Ba, Li, Na, K, and so on may be included. Note that, in the present embodiment, as “included as main components” means that a content ratio in terms of oxide of each element included as the main components is 10 mass % or more (or mol %. The same applies to hereinbelow) or more.

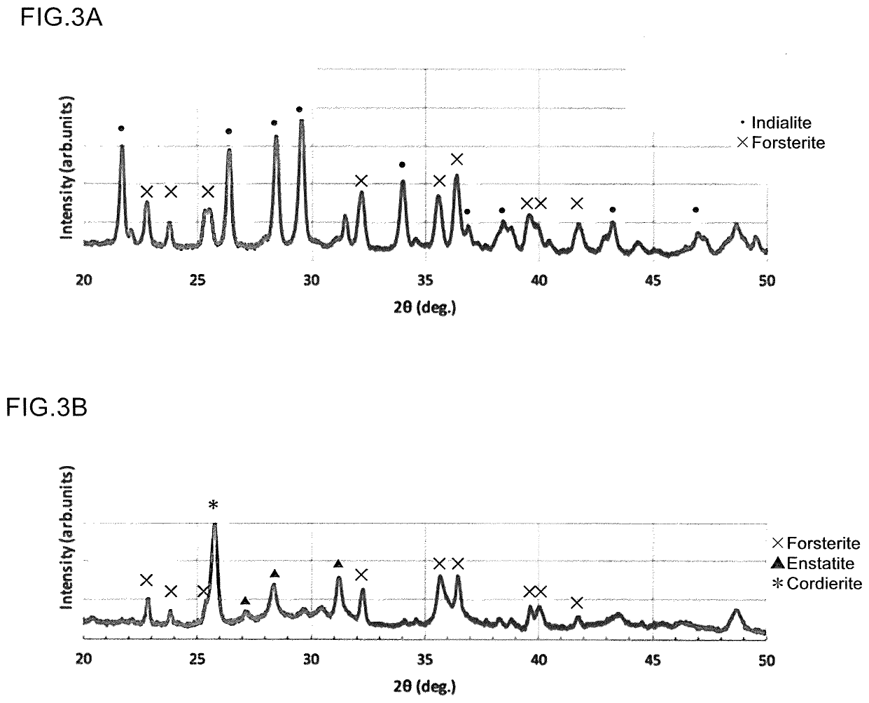

In the present embodiment, the main phase grain 2a1 is configured of a cordierite phase or an indialite phase; and preferably it is configured of an indialite phase. It is possible to determine whether the main phase grain 2a1 is configured of the cordierite phase or the indialite phase from the result of STEM-EDS (for example, FIG. 2A or FIG. 2B) and from XRD analysis (for example, FIG. 3A or FIG. 3B).

The grain size of the main phase grain 2a1 is preferably 0.35 μm or larger, 0.4 μm or larger, 0.5 μm or larger, or 0.55 μm or larger; and preferably 2.2 μm or smaller, 2.15 μm or smaller, 2.0 μm or smaller, or 1.9 μm or smaller. The larger the grain size is, the stronger the chip coil 1 as the electronic component tends to be. However, if the grain size is too large, Q-value tends to decline and also the permittivity tends to increase. For the chip coil 1 for high frequency use, preferably the permittivity is low.

The grain size of the main phase grain 2a1 can be determined by obtaining an area of a main phase grain 2a1 from the cross-section image of SEM, and a diameter of a hypothetical true circle having the same area is determined as the grain size. The same process is carried out to randomly selected 300 or more grains, then the average thereof can be calculated as the grain size of the main phase grain 2a1. Note that, magnification of the cross-section image of SEM is adjusted within a range of 2000× to 10000× so that 300 or more main phase grains are observed in one field of view.

In the present embodiment, the coating layer 2b1 is configured of the forsterite phase; however, an auxiliary coating layer 2c1 configured of a willemite phase may be included as well. The coating layer 2b1 includes Mg, Si, and Zn as main components. It can also be said that the coating layer 2b1 is configured of a composite oxide having more Mg than Zn. The coating layer 2b1 may include oxides of Al, Zr, Ce, Cu, B, Ca, Sr, Ba, Li, Na, K, and so on as other components.

Also, the auxiliary coating layer 2c1 includes Mg, Si, and Zn as main components. It can also be said that the auxiliary coating layer 2c1 is configured of a composite oxide including more Zn than Mg. As other components, this auxiliary coating layer 2c1 may include oxides of the same components as these included the coating layer 2b1. By including Ce or Cu in part of the coating layer 2b1 (2c1), the strength of the electronic component increases. It is thought that these elements are included in the sintered body not as filler particles, rather it is thought that these elements are diffused to the surface of the coating layer 2b1 (2c1) or the main phase grain 2a1.

By including the auxiliary coating layer 2c1 configured of the willemite phase in the coating layer 2b1 configured of the forsterite phase, it is possible to lower the permittivity and increase Q-value.

The thickness of the coating layer 2b1 (also including the auxiliary coating layer 2c1. The same applies hereinafter.) is preferably 0.02 μm or thicker, 0.025 μm or thicker, or 0.05 μm or thicker; and preferably it is 0.6 μm or thinner, 0.55 μm or thinner, or 0.5 μm or thinner.

By maintaining the thickness of the coating layer 2b1 (for example, the thickness corresponds to the forsterite amount or corresponds to the amount of composite oxide including Mg, Si, and Zn as the main components), a thermal expansion coefficient of the coating layer 2b1 is maintained within an appropriate range, hence it is thought to suppress the cracks from generating. Also, for example, this makes it easy to simultaneously fire with the internal electrode layer 3 (for example Ag). Further, by maintaining the thickness of the coating layer 2b1 within an appropriate range, the strength of the chip coil 1 improves. It is thought that the compression stress applied on the main phase grain 2a1 is appropriately maintained, and thus it is thought that the strength has improved.

For example, from the STEM-EDS image shown in FIG. 2A, a thickness of the part having different contrast from the main phase grain 2a1 and stretching around the main phase grain 2a1 is measured, and this is carried out to 30 or more main phase grains and 50 or more points of thicknesses are measured. Then, the average of 50 or more thicknesses are calculated, and the obtained average can be considered as the thickness of the coating layer 2b1 and auxiliary coating layer 2c1. Here, magnification is adjusted within a range of 5000× to 20000× so that 30 or more main phase grains are included in one field of view. Note that, in the present embodiment, the cross-section image of the area of 7.5 μm×7.5 μm of the ceramic sintered body preferably includes 30 or more, 20 or more of the main phase grains 2a1 of which 50% or more of circumference of each main phase grain is covered by the coating layer 2b1 and auxiliary coating layer 2c1.

Alternatively, for example, as similar to FIG. 2A, by using the element distribution of Mg measured by STEM-EDS, the thickness of the Mg layer of the part covering the main phase grain 2a1 is measured, and this is carried out to a plurality of main phase grains and 50 or more points of thicknesses are measured. Then, the average can be calculated as the thickness of the coating layer 2b1. Note that, Mg is the most included element among the elements included as the main components in the coating layer 2b1 configured of the forsterite phase. Also, regarding the thickness of the auxiliary layer 2c1 configured of the willemite phase, as similar to FIG. 2A, by using the element distribution of Zn measured by STEM-EDS, the thickness of the Zn layer covering the main phase grain 2a1 is measured, and this is carried out to a plurality of main phase grains and 50 or more points of thicknesses are measured. Then, the average is calculated from the measured thicknesses, and the obtained average thickness may be considered as the thickness of the auxiliary coating layer 2c1. Note that, Zn is the most included element among the elements included as the main components in the auxiliary coating layer 2c1 configured of the willemite phase.

As shown in FIG. 2A, the ceramic sintered body configuring the ceramic layer may include a first sub-phase grain 2d1 and a second sub-phase grain 2e1 as other grains. The first sub-phase grain 2d1 is mainly configured of Ce oxides and/or Cu oxides, and preferably it exists as part of the coating layer 2b1 or the auxiliary coating layer 2c1. The content ratio of Ce and/or Cu in terms of oxide in the first sub-phase grain 2d1 is, for example, 95 mass % or more, or 97 mass % or more; and as other components, oxides of Si, Zn, Al, and so on may be included by less than 5 mass %, or less than 3 mass %.

The second sub-phase grain 2e1 is mainly configured of Si oxides, and it may exist as part of the coating layer 2b1 or the auxiliary coating layer 2c1. A content ratio of Si in the second sub-phase grain 2e1 in terms of oxide is, for example, 95 mass % or more, 97 mass % or more; and as other components, for example, oxides of Mg, Zn, Al, Ce, and so on may be included by less than 5 mass %, or less than 3 mass %. The second sub-phase grain 2e1 may be included as a SiO₂ filler, an Al₂O₃ filler, or a composite oxide filler made of SiO₂ and Al₂O₃

In the present embodiment, an area ratio of main phase grain 2a1 in one field of view is preferably 30 to 70%, or 40 to 60% when 30 or more main phase grains 2a1 are observed in one field of view of STEM-EDS.

Also, under the same condition, an area ratio of a total of the coating layer 2b1 and the auxiliary coating layer 2c1 (provided that one field of view area is 100%) is not particularly limited, and it may be smaller than the area ratio of main phase grain 2a1. Preferably, an area ratio of the total of the coating layer 2b1 and the auxiliary coating layer 2c1 is about 15 to 45%, or 20 to 40%. Also, the area ratio of the auxiliary coating layer 2cl to the total area of the coating layer 2b1 and the auxiliary coating layer 2c1 is preferably 0 to 73%, 1 to 73%, or 7 to 70%. If the auxiliary coating layer 2c1 made of the willemite phase is too much, the strength of the electronic component declines, and also the thermal expansion coefficient decreases which tends to make it difficult to simultaneously fire with the electrode (such as Ag).

Also, under the same condition, an area ratio of the first sub-phase grain 2d1 in one field of view is preferably 1% or less, 0.5% or less, or 0.3% or less. Also, under the same condition, an area ratio of the second sub-phase grain 2e1 in one field of view is preferably 15% or less, or 13% or less.

### (Method of Production)

Next, a method for producing the chip coil 1 shown in FIG. 1 is described. First, a conductor paste including Ag or so which forms the internal electrode layer 3 shown in FIG. 1 is prepared. The conductor paste can be made by using any known methods.

Separately from the conductor paste, a ceramic paste including a raw material of the glass ceramic sintered body configuring the ceramic layer 2 shown in FIG. 1 is prepared. In the ceramic paste, the raw material is included which becomes the glass ceramic sintered body satisfying the composition and the crystal structure mentioned in above after firing. The raw material of the glass ceramic sintered body is not particularly limited. For example, various oxides, various compounds, and a single or a plurality of types of glass compositions may be used which include metal elements included in the main phase grain 2a1 and the coating layer 2b1, and if needed, metal elements included in the auxiliary coating layer 2c1 and/or sub-phase grains 2d1 and 2e1.

For example, as the raw material, the single or the plurality of types of glass compositions can be pulverized, and other oxide powders, a sintering aid, a filler, and so on may be added, then these can be kneaded together with a binder and a solvent; thereby the ceramic paste can be obtained.

Note that, in the present embodiment, by controlling the amount of Zn included in the glass composition, it is possible to control the area ratio of the auxiliary coating layer 2c1 to the total area of coating layer 2b1 and auxiliary coating layer 2c1 shown in FIG. 2A. For example, by increasing the amount of Zn, the area ratio of the auxiliary coating layer 2c1 can be increased.

Also, for example, by including a small amount of CeO₂ and/or CuO or so having large specific surface area (for example, SSA of 5 m²/g or larger) as the filler, Ce and/or Cu can be included in the coating layer 2b1 and the auxiliary coating layer 2c1. Note that, part of the filler may generate the sub-phase grain 2d1. Also, it is thought that silicon oxide as a filler may generate the sub-phase grain 2e1, and also part of silicon oxide may diffuse to the coating layer 2b1 and the auxiliary coating layer 2c1.

Next, for example, the ceramic paste and the conductor paste are printed in an alternating manner, and the conductor paste patterns on different layers are connected using a through hole or a step; thereby, the conductor pattern of spiral form is formed in the ceramic layer of the multilayer body. Next, if needed, the multilayer body is pressed, and cut into a predetermined size to obtain a green chip, and by firing the green chip, the chip element body 4 shown in FIG. 1 is formed (a printing method).

Alternatively, a green sheet may be produced using a ceramic paste, and an internal electrode layer paste may be printed on the surface of the green sheet, then these may be stacked and fired to produce the chip element 4 (a sheet method). In either way, after the chip element 4 is formed, the terminal electrodes 5 may be formed by baking, plating, or so.

The amount of the binder and the amount of solvent in the ceramic paste are not particularly limited. For example, the amount of the binder may be within a range of 5 to 25 mass %, and the amount of the solvent may be within a range of 30 to 80 mass % in 100 mass % of a total of the whole ceramic paste. Also, if necessary, the paste may include a dispersant, a plaster, and so on within an amount of 20 mass % or less.

The conductor paste including Ag and so on can be made in a similar way. Also, firing conditions and so on are not particularly limited; however, when Ag or so is included in the internal electrode layer, a firing temperature is preferably 960° C. or lower, 920° C. or lower, or 900° C. or lower; and preferably it is 870° C. or higher. By controlling the maximum temperature of firing, for example, the thickness of the coating layer 2b1 and the thickness of the auxiliary thickness 2c1 shown in FIG. 2A can be controlled.

A firing time is not particularly limited, and preferably it is 0.5 to 10 hours or so. The grain size of the main phase grain 2a1 can also be controlled by adjusting the firing time, and the longer the firing time is, the larger the grain size tends to be. A temperature rising rate of firing is not particularly limited, and for example, by increasing the temperature rising rate (for example, increased by 3 times to 10 times of usual temperature rising rate), the grain size of the main phase grain 2a1 shown in FIG. 2A can be enlarged.

Also, by controlling a heat treatment which is carried out after firing at the maximum temperature, the crystal structure of the main phase grain 2a1 can be controlled. For example, after firing at the maximum temperature, by making an annealing time longer at a temperature lower than the maximum firing temperature, the main phase grain 2a1 made of a cordierite phase can be easily formed. Also, by shortening an annealing time after firing at the maximum temperature or by decreasing the temperature without annealing, the main phase grain 2a1 made of the indialite phase can be easily formed.

### SUMMARY OF EMBODIMENTS

The chip coil 1 as an electronic component according to the present embodiment can achieve low permittivity, high strength, and high Q-value at the same time. The reason for this is not necessarily clear, and following is considered as the reason. Generally, the cordierite phase and the indialite phase, particularly the cordierite phase, have relatively lower thermal expansion coefficient compared to that of the forsterite phase. Therefore, by covering the main phase grain with relatively low thermal expression coefficient with the coating layer with relatively high thermal expansion coefficient, stress is kept applied on the main phase grain. Thus, this makes it is difficult for cracks to extend when the stress is applied from outside, hence, low permittivity and high strength can be both achieved, and also high Q-value can be maintained.

Alternatively, the composite oxide including Si, Mg, and Al as the main components for forming the cordierite phase or the indialite phase has lower thermal expansion coefficient compared to the composite oxide including Mg, Si, and Zn as the main components for forming the forsterite phase. Therefore, by covering the main phase grain with relatively low thermal expression coefficient with the coating layer with relatively high thermal expansion coefficient, stress is kept applied on the main phase grain. Thus, this makes it is difficult for cracks to extend when the stress is applied from outside, hence, low permittivity and high strength can be both achieved, and also high Q-value can be maintained.

Also, in the present embodiment, preferably, the main phase grain 2a1 is an indialite phase. Since indialite has higher Q-value than cordierite, low permittivity and high strength can be both achieved, and also Q-value can be further improved.

In the present embodiment, the coating layers 2b1 and 2c1 include the forsterite phase (or the composite oxide including Mg, Si, and Zn as main components in which more Mg is included than Zn/The same applies hereinafter) and also include the willemite phase (or the composite oxide including Mg, Si, and Zn as the main components and including more Zn than Mg). By configuring part of the coating layer with the willemite phase, it is possible to decrease the permittivity and increase Q-value.

In the present embodiment, the coating layers 2b1 and 2c1 include Ce or Cu. By including Ce or Cu in part of the coating layers 2b1 and 2c1, the strength is enhanced. It is thought that these elements are included in the sintered body not as the filler particles, rather it is thought that these elements are diffused on the surface of the coating layer or the main phase grain. Note that, Ce or Cu included as the raw material may be taken into the coating layers 2b1 and 2c1 in the form of oxide particles (the first sub-phase grain 2d1 shown in FIG. 2A).

Note that, the present disclosure is not limited to the above-mentioned embodiments, and various modifications may be carried out within the scope of the present disclosure.

For example, the ceramic sintered body according to the present embodiment can be used as a component of the coil element installed in the semiconductor device. For example, the glass ceramic sintered body of the present embodiment may be processed into a thin film, and it may be installed in the substrate formed with the semiconductor device.

Also, the glass ceramic sintered body according to the present embodiment can be suitably used as a high frequency coil interlayer material.

The glass ceramic sintered body according to the present embodiment has low permittivity and sufficient strength, thus it can be suitably used particularly as an interlayer material configuring the ceramic layer 2 provided between the internal electrode layers 3 and 3.

According to the ceramic sintered body according to the present embodiment, permittivity, strength, and sintering property are improved in a good balance, thus, the electronic component using such ceramic sintered body can achieve high Q-value in high frequency range. The ceramic sintered body is particularly suitable for a high frequency coil used in a frequency range of 1 GHz or higher.

Also, in the above-mentioned embodiment, an example which the ceramic layers 2 used in the chip coil 1 is made of the same material, however, it does not necessarily have to be made of the same material. As mentioned in above, the glass ceramic sintered body according to the present embodiment is particularly suitable as an interlayer material configuring the ceramic layer 2 provided between the internal electrode layers 3 and 3. For a ceramic layer 2 which is not in contact with the coil conductor 30, it may be configured of other ceramic materials.

### EXAMPLES

In below, the present disclosure is described in detail using the further detailed examples; however, the present disclosure is not limited to these examples.

### (Sample No. 1a)

As raw materials, 83 parts by mass or more of a glass powder (silica magnesium aluminum-based glass frit) including Mg, Al, Zn, and Si; 0.5 parts by mass or less of a cordierite powder having a specific surface area (SSA) of 6.4 m²/g or more; 2.0 parts by mass or less of cerium oxide (CeO₂), 15 parts by mass or less of silica filler (SiO₂), 1 parts by mass or less of a sintering aid including B were prepared so that the total of these was 100 parts by mass. Then, these were mixed using a ball mill, and a glass ceramic paste was prepared.

The obtained glass ceramic paste was coated on a PET film using a coater to form a green sheet. Also, an Ag electrode pattern was formed using a screen-printing method on the dried green sheet. After releasing the PET film, the sheet is layered and pressed so that the electrode pattern on each sheet is connected in a spiral form, then, the obtained multilayer body was cut to form a green chip.

The green chip was sintered following the below steps. A temperature was increased from room temperature to 400° C. to carry out a binder removal treatment. The temperature was increased to 800° C. at a temperature rising rate of 1000° C./hour, then the temperature was increased to 900° C. at a temperature rising rate of 200° C./hour. Then, sintering was carried out in the air at 900° C. for 1 hour, then without carrying out an annealing treatment, the temperature was cooled to room temperature at a rate of 200° C./hour, and a sample of chip element 4 shown in FIG. 1 was obtained. The obtained sample of chip element 4 was cut to obtain a sample of a ceramic sintered body which configures a ceramic layer 2. The obtained sample of the ceramic sintered body and the sample of the chip element were subject to the following evaluations.

### <Cross Section Analysis>

A cross section of a sample of a sintered body was analyzed using STEM-EDS, and an image shown in FIG. 2A was obtained. A coating layer 2b1 (in some parts, an auxiliary coating layer 2c1) was confirmed around many of the main phase grains 2a1. Also, the sub-phase grains 2d1 and 2e1 were observed. Compositional analysis of the main phase grain 2a1 showed that it included 45 to 70 mass % of Si in terms of oxide, 15 to 20 mass % of Mg in terms of oxide, 15 to 20 mass % of Al in terms of oxide, 4 mass % or less of Zn in terms of oxide, 0.1 mass % or less of Ce in terms of oxide, and 0.2 mass % or less of Zr in terms of oxide.

Also, the compositional analysis showed that the coating layer 2b1 included 30 to 40 mass % of Si in terms of oxide, 30 to 40 mass % of Mg in terms of oxide, 3 mass % or less of Al in terms of oxide, 20 to 30 mass % of Zn in terms of oxide, 0.1 to 0.2 mass % of Ce in terms of oxide, and 0.3 to 0.7 mol of Zr in terms of oxide.

Further, regarding the sample of the sintered body including the main phase grain 2a1 and the coating layer 2b1, XRD analysis was carried out; and as shown in FIG. 3A, a peak of indialite (black dot) and a peak of forsterite (X) were observed. From the results of STEM-EDS and XRD, it was thought that the main phase grain included the indialite phase and the coating layer 2b1 included the forsterite phase.

Also, using the same analysis methods, it was confirmed that the coating layer 2cl having different contrast from the coating layer 2b1 included 20 to 30 mass % of Si in terms of oxide, 3 to 10 mass % of Mg in terms of oxide, 1 mass % or less of Al in terms of oxide, 60 to 70 mass % of Zn in terms of oxide, 0.1 to 0.2 mass % of Ce in terms of oxide, and 0.2 mol or less of Zr in terms of oxide. It was thought that the coating layer 2c1 included the willemite phase based on comprehensive analysis including other observation results.

Further, using the same analysis methods, it was confirmed that the sub-phase grain 2d1 included 99 mass % or more of Ce in terms of oxide, and the sub-phase grain 2e1 included 99 mass % or more of Si in terms of oxide. Thus, it was confirmed that Ce was diffused to the coating layers 2b1 and 2c1.

### <Size of Main Phase Grain>

A cross section of the sample of the sintered body was analyzed using SEM and the image shown in FIG. 2A was obtained. Here, the field of view was adjusted within a range of 2000× to 10000× so that 300 or more main phase grains were observed in one field of view. From the cross-section areas of 300 or more main phase grains 2a1, circle equivalent diameters were obtained and the average of these was determined as the grain size of the main phase grain. Results are shown in Table 1.

### <Thickness of Coating Layer>

A cross section analysis of the sample of the sintered body was carried out using STEM-EDS to obtain the image shown in FIG. 2A. Here, the magnification was adjusted within a range of 5000× to 20000× so that 30 or more main phase grains were observed in one field of view. Regarding, the thickness of the coating layer 2b1 covering the main phase grain 2a1, the thicknesses of the coating layers 2b1 of randomly selected 50 or more main phase grains 2a1 were measured, and the average thereof was determined as the thickness of the coating layer. The results are shown in Table 1.

### <Specific Permittivity>

Using a network analyzer (made by Agilent Technologies, PNA N5222A) according to a resonance method (JIS R1627), the specific permittivity (no unit) was measured. Note that, in the present example, the specific permittivity of 5.8 or less was considered good, 5.7 or less was considered even better, or 5.6 or less was considered particularly good. Note that, in the tables, the results are indicated as “Permittivity”. Results are shown in Table 1.

### <Strength>

To a prism shape sample of a chip element (outer diameter 20 mm×5 mm×2 mm), a bending strength of the sintered body was measured by a three-point bending test (inter-fulcrum distance: 15 mm) using a universal testing machine 5543 made by INSTRON. Note that, in the present examples, 185 MPa or higher was considered good, and 200 MPa or higher was considered even better. The results are shown in Table 1.

### <Q-Value>

Q-value was measured in accordance with Japan Industrial Standard “Testing method for dielectric properties of fine ceramics at microwave frequency” (JIS R1627-1996). Specifically, a circular prism (pellet) of 15 mm φ×5 mm made of the glass ceramic sintered body was made, and loss tangent (tan δ) was calculated using a both ends dielectric resonator short-circuited method. Further, 1/tan δ=Q. In the present examples, Q-value was 630 or higher; and the higher the Q-value is, the more preferable it is, such as 700 or higher, 800 or higher, 900 or higher, or 1000 or higher. The results are shown in Table 1.

### (Sample No. 1b)

For Sample No. 1b, a chip element and a sample of a sintered body were produced in a similar way as in the case of Sample No. 1a; except that, a glass composition of Sample No. 1b had a smaller amount of Zn than that of the glass composition used in Sample No. 1a and cerium oxide was not included as an additive. The same evaluations carried out in Sample No. 1a were carried out in Sample No. 1b. The results are shown in Table 1.

In the cross section of the glass ceramic sintered body of Sample No. 1b, the sub-phase grain made of oxide of Ce was not observed, and the coating layer 2b1 was observed but the auxiliary coating layer 2c1 was not observed.

### (Sample No. 2)

For Sample No. 2, a sample of a chip element and a sample of a sintered body were produced in a similar way as in the case of Sample No. 1b; except that, for Sample No. 2, a cordierite powder, cerium oxide (CeO₂), silica filler (SiO₂) were not included in the raw material and sintering was carried out at 900° C. for 1 hour, then this was cooled in 15 minutes to 850° C. to carry out 60 minutes of annealing at 850° C. in the air, followed by cooling to room temperature at a temperature decreasing rate of 200° C./hour. The same evaluations carried out in Sample No. 1b were carried out in Sample No. 2. The results are shown in Table 1.

Also, as similar to Sample No. 1a, the result of STEM-EDS image of the glass ceramic sintered body was taken, and the result is shown in FIG. 2B.

As shown in FIG. 2B, a main phase grain 2a2 was confirmed to be a cordierite phase, and a main phase grain surface layer 2b2 covering the surface of the main phase grain 2a2 was confirmed to include 45 to 50 mass % of Si in terms of oxide, 15 to 20 mass % of Mg in terms of oxide, 5 to 8 mass % of Al in terms of oxide, and 25 to 30 mass % of Zn in terms of oxide. Further, the main phase grain surface layer 2b2 was richer in Zn than the main phase grain 2a2, also it was confirmed that the main phase grain surface layer 2b2 was neither of forsterite or willemite. That is, Sample No. 2 as a comparative example did not have the coating layers 2b1 and 2c1 shown in Sample Nos. 1a and 1b as examples. In the table, the absence of the coating layers 2b1 and 2c1 are indicated by “-”.

In Sample No. 2 as a comparative example, a third sub-phase grain 2c2, a fourth sub-phase grain 2d2, and an amorphous phase 2e2 were observed. Note that, in the examples, the amorphous phase 2e2 was not observed. A third sub-phase 2c2 was confirmed to be made of a willemite phase, and the fourth sub-phase grain 2d2 was confirmed to be made of a forsterite phase or an enstatite phase.

### (Sample No. 3)

A sample of a chip element and a sample of a sintered body of Sample No. 3 were produced in a similar way as in the case of Sample No. 1b; except that, in Sample No. 3, sintering was carried out at 900° C. for 1 hour, and it was cooled to 850° C. in 15 minutes, followed by 60 minutes of annealing was carried at 850° C. in the air, and then it was cooled to room temperature at a rate of 200° C./hour. The same evaluations as in the case of Sample No. 1b were carried out in Sample No. 3. The results are shown in Table 1. The main phase grain was confirmed to be a cordierite phase.

### (Sample No. 4)

A sample of a chip element and a sample of a sintered body of Sample No. 4 were produced in a similar way as in the case of Sample No. 2; except that, for Sample No. 4, an annealing treatment was not carried out. The same evaluations as in the case of Sample No. 2 were carried out in Sample No. 4. The results are shown in Table 1. The main phase grain was confirmed to be a cordierite phase.

### (Evaluation 1)

As shown in Table 1, the examples of Sample Nos. 1a, 1b, and 3 in which the coating layer made of cordierite phase was formed had higher strength and higher Q-value compared to Sample Nos. 2 and 4 as comparative examples. Particularly, the example in which the main phase grain was made of indialite phase had particularly improved Q-value and the strength compared to the examples in which the main phase grain was made of cordierite phase.

### (Sample Nos. 5 to 8)

For Sample Nos. 5 to 8, a sample of a chip element and a sample of a sintered body were produced in a similar way as in the case of Sample No. 3; except that, the size of the main phase grain was adjusted to the size shown in Table 2 by controlling the firing time and the temperature rising time. The same evaluations as in the case of Sample No. 3 were carried out to the Sample Nos. 5 to 8. The results are shown in Table 2. Note that, in Table 2, when the thickness of the coating layer was 0.02 μm or thicker, then it was indicated “present” in the column of the coating layer. Also, the longer the firing time was, the larger the grain size tended to be. Also, by increasing the temperature rising rate, it was confirmed that the grain size can be enlarged.

### (Sample Nos. 9 to 12)

A sample of a chip element and a sample of a sintered body of Sample Nos. 9 to 12 were produced in a similar way as in the case of Sample No. 1b; except that, in Sample Nos. 9 to 12, the size of the main phase grain was adjusted to a size as shown in Table 2 by controlling the firing time and the temperature rising time as similar to the case of Sample Nos. 5 to 8. The same evaluations as in the case of Sample No. 1b were carried out in Sample Nos. 9 to 12. Note that, in Table 2, when a thickness of the coating layer was confirmed to be 0.02 μm or thicker, then it was indicated “present” in the column of the coating layer. The results are shown in Table 2.

### (Evaluation 2)

As shown in Table 2, in each example with different main phase grain size, it was confirmed that the coating layer was formed and that the ceramic sintered body with low permittivity, high strength, and high Q-value was achieved. Also, as the main phase grain size becomes larger, the permittivity tended to increase, the strength tended to increase, and Q-value tended to decrease. Particularly, the example in which the main phase grain was made of an indialite phase had particularly improved Q-value compared to the examples in which the main phase grain was made of a cordierite phase.

### (Sample No. 13 to 16)

Samples of sintered body samples of Sample No. 13 to 16 were produced in a similar way as in the case of Sample No. 3 and the same evaluations as in the case of Sample No. 3 were carried out, except that a thickness of the coating layer was varied by controlling the maximum temperature and the holding time during firing compared to those of Sample No. 3. Results are shown in Table 3. Note that, the higher the maximum temperature of firing was, the thicker the coating layer tended to be; and the longer the holding time at the maximum temperature of firing was, the thicker the coating layer was.

Also, a crack test was carried out in the order described in below, The results of the crack test is also shown in Table 3.

### <Crack Test>

Fifty samples of the chip elements were prepared, and the crack test was carried out using the below described method.

The chip element sample with each Sample number was soldered on the center of a substrate (a glass epoxy substrate having a size of 100 mm×40 mm, and the thickness of 0.08 mm). Then, load was applied in a deflection amount of 1.2 mm for 5 seconds to the other surface (substrate backside) which is opposite surface where the sample was soldered, and presence of cracks on the outside and inside of the sample after the load application was evaluated.

The fewer cracks were, the more preferable it was.

### (Sample Nos. 17 to 20)

Sintered bodies of Sample Nos. 17 to 20 were produced in a similar way as in the case of Sample No. 1b and the same evaluations as in the case of Sample Nos. 13 to 16 were carried out; except that the thickness of the coating layer of Sample Nos. 17 to 20 were varied by controlling the maximum temperature of firing compared to Sample No. 1b. The results are shown in Table 3.

### (Evaluation 3)

As shown in Table 3, even in the case of examples with different coating layer thicknesses, it was confirmed that a ceramic sintered body achieving low permittivity, high strength, high Q-value at the same time can be obtained. Further, it was confirmed that the thicker the coating layer was, the higher the permittivity was, and the lower the Q-value was. Also, as the coating layer becomes thicker, the strength was improved and internal cracks tended to decrease; however, it was also confirmed that if the coating layer was too thick, there was tendency that the strength may decline, and the internal cracks may increase.

### (Sample Nos. 21 to 25)

Samples of sintered bodies of Sample Nos. 21 to 25 were produced in a similar way as Sample No. 3 and the same evaluations as in the case of Sample Nos. 13 to 16 were carried out; except that, a ratio (area ratio) of the willemite phase in the coating layer was adjusted as shown in Table 4 by controlling the amount of Zn in the glass composition and by controlling the sintering temperature (the maximum temperature during firing). The results are shown in Table 4. Note that, in Table 4, when the area ratio of the forsterite phase in the field of view was 3.5% or more, then it was indicated “present” in the column of forsterite.

### (Sample Nos. 26 to 30)

Samples of sintered bodies of Sample Nos. 26 to 30 were produced in a similar way as Sample No. 1b and the same evaluations as in the case of Sample Nos. 17 to 20 were carried out; except that, a ratio (area ratio) of the willemite phase in the coating layer was adjusted as shown in Table 4 by controlling the amount of Zn in the glass composition. The results are shown in Table 4. Note that, in Table 4, when the area ratio of the forsterite phase in the field of view was 3.5% or more, then it was indicated “present” in the column of forsterite.

### (Evaluation 4)

As shown in Table 4, even when the examples had different coating layer thicknesses, it was confirmed that a ceramic sintered body achieving low permittivity, high strength, high Q-value at the same time can be obtained. Also, by increasing the ratio of the willemite phase in the coating layer, the permittivity tended to decrease, the strength tended to decrease, and Q-value tended to increase. As the reason of decreased strength which caused increased number of cracks, it is thought that the thermal expansion coefficient had decreased due to the increased amount of willemite. Note that, it was confirmed that the ratio of the willemite phase increased in the coating layer when the amount of Zn in the glass composition was increased. Also, when the amount of Zn in the glass composition was increased, it was confirmed that the sintering temperature can also be lowered.

### (Sample Nos. 31 to 37)

Samples of chip elements and samples of sintered bodies of Sample Nos. 31 to 37 were produced in a similar way as Sample No. 3 and the same evaluations as in the case of Sample No. 3 were carried out; except that, ratios of CeO₂ and/or CuO in the coating layer were adjusted as indicated in Table 5 by adjusting the amount of oxides of Ce and/or Cu in the raw materials. The results are shown in Table 5. Note that, in Table 5, when the area ratio of the forsterite phase in the field of view was 3.5% or more, then it was indicated “present” in the column of forsterite.

### (Sample Nos. 38 to 44)

Samples of chip elements and samples of sintered bodies of Sample Nos. 38 to 44 were produced in a similar way as Sample No. 1b and the same evaluations as in the case of Sample No. 1b were carried out; except for adjusting a mass % of CeO₂ and/or CuO in the coating layer as indicated in Table 5 by adjusting the amount of oxides of Ce and/or Cu in the raw materials. The results are shown in Table 5. Note that, in Table 5, when the area ratio of the forsterite phase in the field of view was 3.5% or more, then it was indicated “present” in the column of forsterite.

### (Evaluation 5)

As shown in Table 5, even in the case of the examples including Ce and/or Cu in the coating layer, it was confirmed that a ceramic sintered body achieving low permittivity, high strength, high Q-value at the same time can be obtained. Also, compared to Sample No. 3 in which neither Ce nor Cu were included in the coating layer, it was confirmed that Sample Nos. 31 to 37 can achieve higher strength and Q-value. Also, compared to Sample No. 1b in which neither Ce nor Cu were included in the coating layer, it was confirmed that Sample Nos. 38 to 44 can achieve higher strength and Q-value.

TABLE 1

| | | | Main phase | Coating layer | | | |
|---|---|---|---|---|---|---|---|
| Sample | | | grain size | thickness | | Strength | |
| No. | | Main phase grain | (μm) | (μm) | Permittivity | (MPa) | Q |
| 1 a | Example | Indialite | 0.9 | 0.14 | 5.7 | 234 | 1240 |
| 1 b | Example | Indialite | 0.9 | 0.14 | 5.7 | 228 | 1180 |
| 2 | Comparative | Cordierite | 1.42 | — | 5.7 | 135 | 200 |
| | example | | | | | | |
| 3 | Example | Cordierite | 0.85 | 0.15 | 5.7 | 225 | 780 |
| 4 | Comparative | Indialite | 1.33 | — | 5.7 | 132 | 350 |
| | example | | | | | | |

TABLE 2

| | | | Main phase | | | | |
|---|---|---|---|---|---|---|---|
| Sample | | | grain size | Coating | | Strength | |
| No. | | Main phase grain | (μm) | layer | Permittivity | (MPa) | Q |
| 5 | Example | Cordierite | 0.35 | Present | 5.5 | 193 | 900 |
| 6 | Example | Cordierite | 0.5 | Present | 5.6 | 205 | 850 |
| 3 | Example | Cordierite | 0.85 | Present | 5.7 | 225 | 780 |
| 7 | Example | Cordierite | 2 | Present | 5.7 | 230 | 750 |
| 8 | Example | Cordierite | 2.2 | Present | 5.7 | 234 | 680 |
| 9 | Example | Indialite | 0.4 | Present | 5.5 | 199 | 1400 |
| 10 | Example | Indialite | 0.55 | Present | 5.6 | 210 | 1350 |
| 1 b | Example | Indialite | 0.9 | Present | 5.7 | 228 | 1180 |
| 11 | Example | Indialite | 1.9 | Present | 5.7 | 232 | 1050 |
| 12 | Example | Indialite | 2.15 | Present | 5.7 | 236 | 980 |

TABLE 3

| | | | Coating layer | | | | |
|---|---|---|---|---|---|---|---|
| Sample | | | thickness | | Strength | Q | |
| No. | | Main phase grain | (μm) | Permittivity | (MPa) | value | Cracks |
| 13 | Example | Cordierite | 0.025 | 5.4 | 185 | 970 | 7/50 |
| 14 | Example | Cordierite | 0.07 | 5.6 | 205 | 850 | 1/50 |
| 3 | Example | Cordierite | 0.15 | 5.7 | 225 | 780 | 0/50 |
| 15 | Example | Cordierite | 0.47 | 5.7 | 220 | 700 | 0/50 |
| 16 | Example | Cordierite | 0.6 | 5.8 | 190 | 630 | 6/50 |
| 17 | Example | Indialite | 0.02 | 5.4 | 187 | 1390 | 5/50 |
| 18 | Example | Indialite | 0.05 | 5.6 | 200 | 1270 | 1/50 |
| 1 b | Example | Indialite | 0.14 | 5.7 | 228 | 1180 | 0/50 |
| 19 | Example | Indialite | 0.5 | 5.7 | 218 | 1050 | 0/50 |
| 20 | Example | Indialite | 0.55 | 5.8 | 195 | 970 | 5/50 |

TABLE 4

| | | | | Willemite/ | | | | |
|---|---|---|---|---|---|---|---|---|
| | | | | (Forsterite + | | | | |
| Sample | | | Coating layer | Willemite) | | Strength | | |
| No. | | Main phase grain | Forsterite | (%) | Permittivity | (MPa) | Q value | Cracks |
| 3 | Example | Cordierite | Present | 0 | 5.7 | 225 | 780 | 0/50 |
| 21 | Example | Cordierite | Present | 7 | 5.7 | 223 | 800 | 0/50 |
| 22 | Example | Cordierite | Present | 12 | 5.6 | 218 | 850 | 0/50 |
| 23 | Example | Cordierite | Present | 25 | 5.5 | 215 | 850 | 0/50 |
| 24 | Example | Cordierite | Present | 70 | 5.3 | 209 | 880 | 1/50 |
| 25 | Example | Cordierite | Present | 73 | 5.2 | 196 | 890 | 7/50 |
| 1 b | Example | Indialite | Present | 0 | 5.7 | 228 | 1180 | 0/50 |
| 26 | Example | Indialite | Present | 7 | 5.7 | 225 | 1200 | 0/50 |
| 27 | Example | Indialite | Present | 10 | 5.6 | 220 | 1240 | 0/50 |
| 28 | Example | Indialite | Present | 23 | 5.5 | 217 | 1250 | 0/50 |
| 29 | Example | Indialite | Present | 69 | 5.3 | 211 | 1280 | 2/50 |
| 30 | Example | Indialite | Present | 72 | 5.2 | 197 | 1350 | 6/50 |

TABLE 5

| | | | Coating layer | | | | | |
|---|---|---|---|---|---|---|---|---|
| Sample | | | | Ce | Cu | | Strength | |
| No. | | Main phase grain | Forsterite | (mass %) | (mass %) | Permittivity | (MPa) | Q value |
| 3 | Example | Cordierite | Present | 0 | 0 | 5.7 | 225 | 780 |
| 31 | Example | Cordierite | Present | 0.05 | 0 | 5.7 | 230 | 800 |
| 32 | Example | Cordierite | Present | 0.17 | 0 | 5.7 | 255 | 850 |
| 33 | Example | Cordierite | Present | 0.48 | 0 | 5.7 | 285 | 800 |
| 34 | Example | Cordierite | Present | 0 | 0.06 | 5.7 | 233 | 805 |
| 35 | Example | Cordierite | Present | 0 | 0.1 | 5.7 | 248 | 820 |
| 36 | Example | Cordierite | Present | 0 | 0.47 | 5.7 | 272 | 810 |
| 37 | Example | Cordierite | Present | 0.1 | 0.1 | 5.7 | 252 | 840 |
| 1 b | Example | Indialite | Present | 0 | 0 | 5.7 | 228 | 1180 |
| 38 | Example | Indialite | Present | 0.06 | 0 | 5.7 | 234 | 1210 |
| 39 | Example | Indialite | Present | 0.15 | 0 | 5.7 | 260 | 1280 |
| 40 | Example | Indialite | Present | 0.5 | 0 | 5.7 | 290 | 1220 |
| 41 | Example | Indialite | Present | 0 | 0.05 | 5.7 | 231 | 1120 |
| 42 | Example | Indialite | Present | 0 | 0.2 | 5.7 | 245 | 1100 |
| 43 | Example | Indialite | Present | 0 | 0.46 | 5.7 | 270 | 1080 |
| 44 | Example | Indialite | Present | 0.15 | 0.15 | 5.7 | 253 | 1230 |

### REFERENCE SIGNS LISTS

1 . . . Chip coil
2 . . . Ceramic layer
2a1 . . . Main phase grain (cordierite/indialite)
2b1 . . . Coating layer (forsterite)
2c1 . . . Auxiliary coating layer (willemite)
2d1 . . . First sub-phase grain (cerium oxide)
2e1 . . . Second sub-phase grain (silicon oxide)
2a2 . . . Main phase grain (cordierite)
2b2 . . . Main phase surface layer (Zn rich)
2c2 . . . Third sub-phase grain (willemite)
2d2 . . . Fourth sub-phase grain (forsterite/enstatite)
2e2 . . . Amorphous phase (silicon oxide)
3 . . . Internal electrode layer
3a, 3b . . . Lead electrodes
30 . . . Coil conductor
4 . . . Chip element
5 . . . Terminal electrode

What is claimed is:

1. An electronic component, comprising:
a glass ceramic sintered body, wherein
the glass ceramic sintered body comprises a main phase grain including at least one of a cordierite phase and an indialite phase, and a coating layer including a forsterite phase covering the main phase grain.

2. The electronic component according to claim 1, wherein the main phase grain comprises the indialite phase.

3. The electronic component according to claim 1, wherein a grain size of the main phase grain is 0.35 μm or larger.

4. The electronic component according to claim 1, wherein a thickness of the coating layer is 0.02 μm or thicker.

5. The electronic component according to claim 1, wherein the coating layer includes a willemite phase.

6. The electronic component according to claim 5, wherein an area ratio of the willemite phase to a total area of the forsterite phase and the willemite phase in the coating layer is 1% to 73%.

7. The electronic component according to claim 1, wherein the coating layer comprises Ce or Cu.

8. An electronic component, comprising:
a glass ceramic sintered body, wherein
the glass ceramic sintered body comprises a main phase grain including a composite oxide including Si, Mg, and Al as main components, and a coating layer covering the main phase grain and including a composite oxide including Mg, Si, and Zn as main components.
